(19) United States
(12) Patent Application Publication
(10) Pub. No.: US 2026/0243885 A1
(43) Pub. Date: Aug. 20, 2026

(54) System for detecting the position of a target located within a reference space

(71) Applicant: Adant Technologies, Inc., Wilmington, DE (US)

(72) Inventors: Marco De Gregorio, Treviso (IT); Daniele Piazza, Padova (IT)

(21) Appl. No.: 18/876,680

(22) PCT Filed: Jun. 29, 2023
(86) PCT No.: PCT/IB2023/056804

§ 371 Date: Dec. 19, 2024

(30) Foreign Application Priority Data
Jun. 30, 2022 (IT) 102022000013903

(51) Int. Cl. G01S 13/87; G01S 13/42

(52) U.S. Cl. CPC G01S 13/878; G01S 13/42

(57) ABSTRACT

A system for determining the position of a target located within a reference space, using the radiation within the reference space of an electromagnetic signal containing information associated with the target, includes a plurality of antenna modules formed by at least two antennas configured to receive the electromagnetic signal containing the information associated with the target, a radio chain operatively connected to the plurality of modules to receive from each module an electrical signal associated with the electromagnetic signal, a first switching device interposed between the radio chain and the plurality of modules, and a processor operatively connected to the radio chain to process information associated with the electrical signal received by the radio chain. The first switching device has a single input operatively connected to the radio chain and a plurality of outputs operatively connected to each module.

### FIELD OF APPLICATION OF THE INVENTION

The present invention relates to the technical field of radio transmission and object position tracking and has as its object a system for determining the position of a target located in a reference space.

### STATE OF THE ART

As well known, systems for tracking an object located within a reference space consist of a plurality of devices suited to promote the radiation and the reception of electromagnetic signals propagating within such reference space.

An example of these devices is illustrated in Figures from 1 to 3.

In brief, the well-known systems for determining the position of an object placed within a reference space are provided with a plurality of substantially modular devices Q arranged in such a way as to cover with the electromagnetic radiation emitted/received by them a predetermined sector of space.

In the configuration of the system shown in FIG. 1, there are four modules arranged to cover with the radiation emitted/received a predetermined and mutually distinct portion of space.

Each module comprises within it a plurality of antennas A connected to a radio chain C.

The radio chain is constituted by a complex electronic circuit whose function is mainly to generate a first electrical signal intended to be sent to the antennas and to process a second electrical signal received by the antennas.

Essentially, these systems are configured to r adiate into the reference space a first electromagnetic signal of a predetermined frequency and receive a second electromagnetic signal that is generated as a result of the interaction that takes place between the first signal and an object (or target) located within the space. Conveniently, these systems can be configured to operate exclusively in reception, that is, in the presence of the second electromagnetic signal (without the generation of the first electromagnetic signal).

The first electromagnetic signal will be emitted by the transmitting antenna provided in each single module, while the second electromagnetic signal will be received by one or more receiving antennas in the same module.

The second electromagnetic signal is transduced into a second electrical signal by the receiving antennas of the module.

This second electrical signal is then processed by the radio module so as to determine certain electrical features associated with the same signal.

These features, associated with the second electrical signal, can be represented by the frequency, waveform, phase, power, etc.

The information associated with the parameters of the second electrical signal is then processed by a processing unit U, which provides as output information on the angle of arrival of the signal (AoA) and/or the distance of the target from the radio module; this information is then further processed (individually or with information from multiple systems) to estimate the position of the target.

This estimation is typically computed according to algorithms based on the estimation of the time of flight (ToA) of the signal and/or the estimation of the angle of arrival of the signal (AoA) or the angle of departure (AoD)). An alternative configuration of these systems allows the target position to be estimated using only the angle of arrival of the signal (AoA); in this, however, it is necessary to involve a plurality of systems suited to cooperate with each other so as to define the target position by interpolating the individual information of the AoA associated with each of such systems.

A first configuration of the modules that make up the standard systems for determining the position of an object within a reference space is schematically shown in FIG. 2.

In this configuration, the use of a switching device H (typically a switch) having a single input connected to the radio chain and a plurality of outputs connected to the module antennas is provided.

The selective activation of the switching device H allows radio chain C to selectively connect to one antenna at a time from among those contained in the module.

A second configuration of the modules that constitute the standard systems for determining the position of an object within a reference space is schematically shown In FIG. 3.

In this case, there is no switching device and each module antenna is directly connected to the C radio module.

However, both systems made according to the scheme in FIG. 2 and those made according to the scheme in FIG. 3 are affected by some important components.

First of all, the systems described above typically consist of a plurality of independent modules connected to the same processing unit and are suited to promote the transmission and reception of electromagnetic signals propagating in a predetermined portion of three-dimensional space.

The particular configuration of these systems is particularly expensive because it involves the duplication of many circuit parts placed both upstream and downstream of the radio chain.

In addition, the presence of modular parts that must operate in a synchronized manner with each other greatly increases the complexity of the system.

A further drawback of this type of system, when used individually, is that the determination of the target position is subject to considerable tolerances since the installation of a plurality of antenna modules that are independent of each other can generate shadow areas that fail to be covered by the emission of the first electromagnetic signal.

Moreover, known systems have a high approximation and uncertainty in estimating the angle of arrival of the signal (AoA), as well as, in the case of some particular applications, relatively large dimensions that make them difficult to install in small environments.

Documents US2018/084371 and US2021/302528 describe two particular system configurations for determining the position of a target located in a predetermined reference space. These documents, however, have the same drawbacks mentioned above.

### Presentation of the Invention

The present invention is intended to overcome the technical drawbacks mentioned above by providing a particularly efficient and high-performance system for determining the position of a target located in a reference space.

More specifically, the main purpose of the present invention is to provide a system for determining the position of a target located in a reference space that has reduced complexity of production.

A further purpose of the present invention is to provide a system for determining the position of a target located in a reference space that is particularly simple to design and implement.

Another purpose of the present invention is to provide a system for determining the position of a target located in a reference space that is particularly compact and suitable for installation in a wide type of environments.

A further purpose of the present invention is to make available a system capable of estimating the position of a target located in a reference space in a particularly precise and accurate manner.

Another purpose of the present invention is to provide a system for determining the position of a target located in a reference space that is particularly stable in operation and robust with respect to external agents so as to exhibit high reliability.

These purposes, together with others that will be better elucidated below, are achieved by a system for determining the position of a target located in a reference space of the type in accordance with claim 1.

Other purposes that will be better described below are achieved by a system for determining the position of a target located in a reference space in accordance with dependent claims.

### BRIEF DESCRIPTION OF THE DRAWINGS

The advantages and features of the present invention will clearly emerge from the following detailed description of some preferred but not limiting configurations of a system for determining the position of a target located in a reference space with special reference to the following drawings:

Figures from 1 to 3 represent simplified schemes of systems for determining the position of a target located in a reference space per se known in the state of the art;

FIG. 4 represents a simplified scheme of a system for determining the position of a target located in a reference space subject of the present invention in a first embodiment;

FIG. 5 represents a simplified scheme of a system for determining the position of a target located in a reference space subject of the present invention in a second embodiment.

### DETAILED DESCRIPTION OF THE INVENTION

The present invention relates to a system 1 for determining a target k located within a reference space.

In particular, the system object of the present invention permits to estimate the position of a target k within a physical space by means of interaction of a target k with an electromagnetic radiation propagating within such space.

Conveniently, the target object of the present invention can be, with respect to electromagnetic radiation, of passive or active type.

A passive target substantially consists of an object that is not arranged to radiate an its own electromagnetic signal. Essentially, the passive target is only capable of reflecting the electromagnetic radiation already present within the reference space, but it cannot generate any signal of its own.

The active target, on the other hand, is characterized in that it emits its own electromagnetic signal, usually in response to an electromagnetic signal previously radiated within the reference space.

This type of targets, for example consisting of RFID elements, are configured to:
receive a reference electromagnetic signal specially radiated within the reference space;
after such reception, emit in the reference space a different electromagnetic signal than that received.

Alternatively, an active-type target can also be configured to emit a signal into the space in an independent manner, that is, in the absence of a reference electromagnetic signal that must be previously radiated within the space.

By means of the system that is the subject of the present invention, it is possible to locate the position of a target k within a reference space, that is to determine with a good degree of approximation the distance that the latter has with respect to a fixed point used as a reference p (which may be internal or external to the three-dimensional space itself).

Moreover, the target k may be fixed, that is having a stationary position within the reference space.

Alternatively, the target k used in the present system may be movable within the reference space; in this case, the system will be able to provide information in relation to the motion/trajectory that such target k describes with respect to the reference point p.

Conveniently, the system 1 subject of this invention has a plurality of antenna modules (i.e., at least two modules).

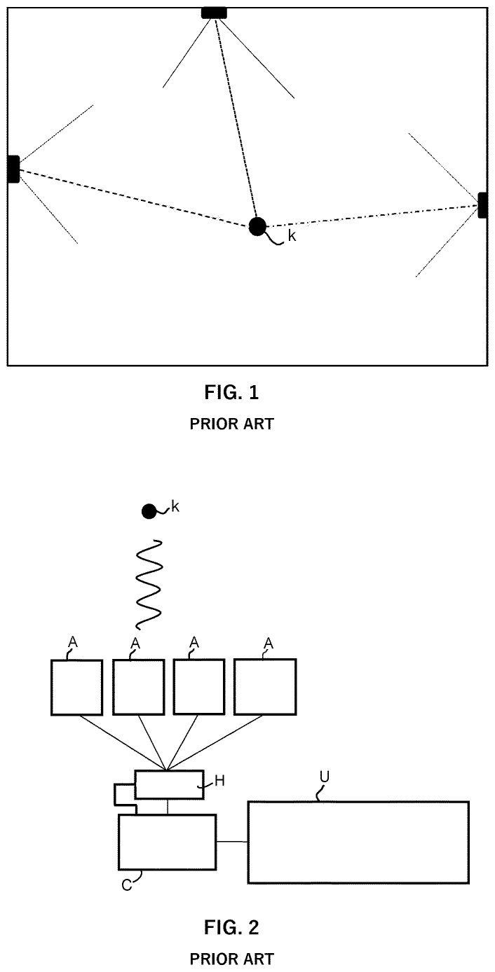

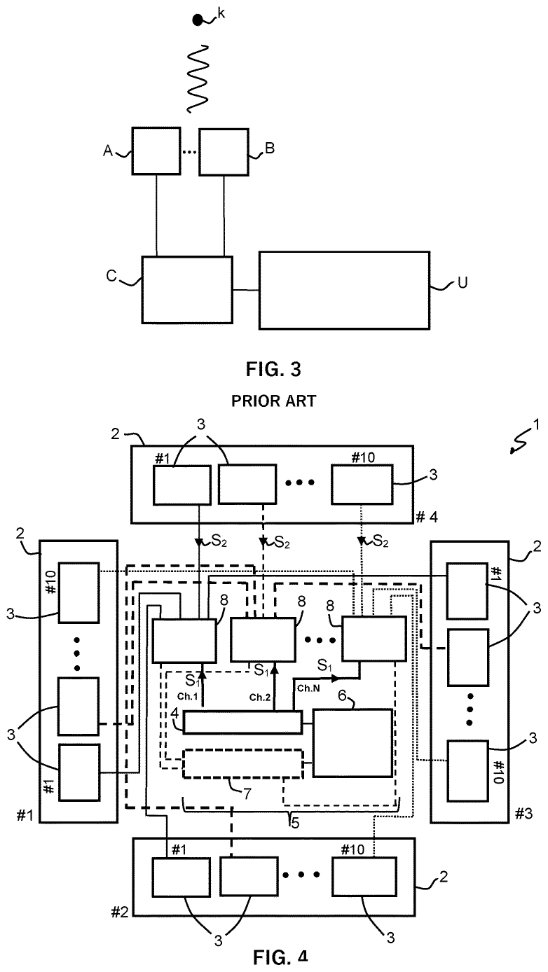

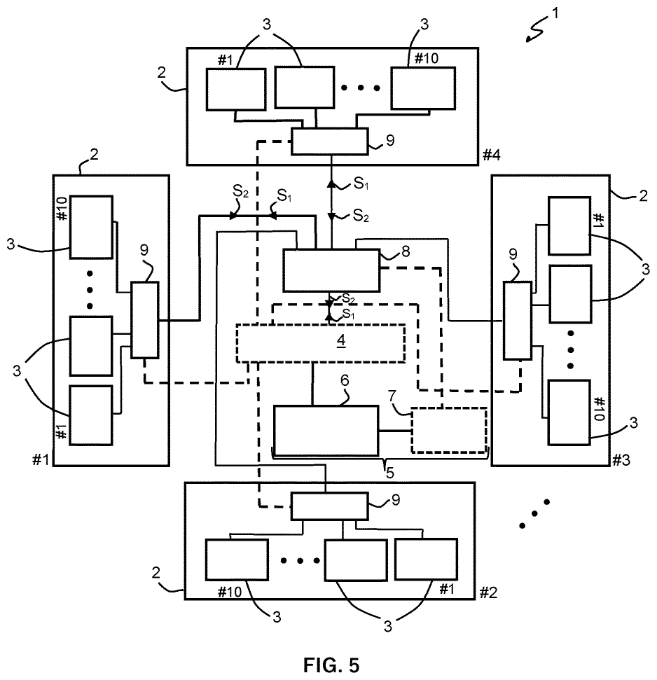

These modules are schematized in FIGS. 4 and 5 with the reference number 2.

Conveniently, the total number of antenna modules 2 used in a single system 1 is represented by an integer value greater than one.

This value is defined in the present description with the expression “first predetermined value” and will be indicated with the reference letter M.

In the configuration of system 1 illustrated in FIG. 4 and FIG. 5, the first value M is equal to four (M=4); in other words, the system 1 comprises four distinct antenna modules 2.

It is, however, intended that the value associated with M can be other than four (M≠4) and system 1 can use an arbitrary number of antenna modules 2 that are distinct and separate from each other.

The expression “distinct and separate” used in this context is intended to refer to antenna modules 2 that are substantially independent from each other and that require a stand-alone connection to function. In other words, the operation of each antenna module 2 does not depend on the operation of the other modules 2 which, therefore, can also be temporarily disabled without affecting the functionality of the modules 2 that are to be kept active.

Each antenna module 2 consists of a plurality of antennas 3 suited to enable the transmission/reception of an electromagnetic signal.

The expression “antenna module” used in this description intends to refer to a device provided with two or more antennas 3 suited to define the following features:
a) each single antenna 3 of the module 2 can be connected to other system's devices independently of the other antennas 3; or, alternatively:
a′) two or more antennas 3 of the module 2 can be electrically connected together according to a predetermined connection configuration (typically in parallel);
b) the antennas 3 of the module 2 are configured to receive (and eventually emit) electromagnetic signals suited to cover a predetermined three-dimensional region of the space (e.g., the azimuth angle covered by each antenna may have an extent a less than or equal to the flat angle). In this way, each single module 2 cannot be omnidirectional since the latter is suited to receive (and possibly radiate) electromagnetic signals in a limited and defined region of space;
c) modules 2 are formed by one or more antennas 3 of directional type, i.e., suited to emit/radiate in the same direction (so as to define a limited region of the three-dimensional space).

In view of the above, it is evident that the system 1 subject of this invention always consists of a plurality of modules 2 of antennas 3 (at minimum, a pair of modules).

In addition, the antennas 3 constituting the module 2 can be configured to:
i) operate in a bidirectional manner: radiate a first electromagnetic signal S₁ into the space (henceforth identified by the expression “first electromagnetic signal”) and receive an electromagnetic signal S₂ (henceforth identified by the expression “second electromagnetic signal”) suited to contain information about the position of the target k;
ii) operate in a unidirectional manner: receive exclusively a second electromagnetic signal S₂ suited to contain information on the target position.

Conveniently, the system may comprise two or more antenna modules that are equal to each other (e.g., provided with the same number of antennas, the same type of antennas, etc.) or different from each other (e.g., provided with a different number of antennas and/or different types of antennas and/or antennas with different features etc.).

In the bidirectional form, described later in this description, modules 2 thus consist of an array of antennas 3 electrically connected in such a way as to define:
at least one antenna 3 suited to radiate in the three-dimensional space a first electromagnetic signal S₁;
at least one antenna 3 suited to receive a second electromagnetic signal S₂ coming from the target k located in the reference three-dimensional space.

From a functional point of view, therefore, each antenna module 2 is suited to transmit and receive electromagnetic signals in an autonomous and independent manner from the other modules 2 used in system 1.

As known from theory of electromagnetic waves, it is possible to determine the position of a target k located within a reference space through physical quantities associated with the radiation and reception of electromagnetic signals interacting with the target k itself.

In general, the function of antenna modules 2 is to promote the radiation in three-dimensional space of a first electromagnetic signal S₁.

The first electromagnetic signal S₁ is characterized by having a plurality of predetermined electrical parameters. Some of such parameters are listed here in the following:
the frequency and wavelength (or respective ranges of frequencies and wavelengths);
the amplitude of the first electromagnetic signal S₁;
the polarization.

The first electromagnetic signal S₁ is intended to be radiated by antenna modules 2 within the reference three-dimensional space.

In particular, the first electromagnetic signal S₁ may invade and propagate throughout all the reference three-dimensional space.

Alternatively, it is possible to radiate most of the energy associated with the first electromagnetic signal S₁ directed into a precise region of the reference space; in this case, the first electromagnetic signal S₁ will be suited to propagate in a limited region of the reference three-dimensional space.

In the first case (propagation throughout the whole space), the antenna 3 of the module 2 suited to promote the transmission of the first electromagnetic signal S₁ can have a radiation pattern that is substantially omnidirectional, while in the second case such antenna 3 will be substantially directive with a radiation diagram provided with a main lobe and two or more secondary lobes.

As will be better described later in this description, each module 2 of system 1 comprises at least one antenna 3 suited to radiate the first electromagnetic signal S₁ within the reference space.

The transmitting antennas 3 of each module 2 may be of omnidirectional or directional type, depending on the type of installation to which the system 1, subject of the present invention, is subjected.

The interaction of the first electromagnetic signal S₁ with the target k located in the reference space causes the generation of a second electromagnetic signal S₂.

Conveniently, the first electromagnetic signal S₁ propagates from the transmitting antenna 3 of each module 2 to the target k, while the second electromagnetic signal S₂ follows an opposite propagation path, that is, from the target k to the antenna modules 2.

The second electromagnetic signal S₂ is characterized by having one or more electrical parameters different than the first electromagnetic signal S₁. Hereunder is listed one or more parameters that may be different between the two signals:
the power;
the polarization;
the phase.

If the target k is of the passive type, the second electromagnetic signal S₂ is generated as a result of the reflection that the first electromagnetic signal S₁ undergoes at target k itself.

In this case, certain electrical parameters associated with the first electromagnetic signal S₁ remain essentially the same also in the second electromagnetic signal S₂ (e.g., frequency and wavelength).

If the target k is of the active type, the stimulation that the latter undergoes as a result of interacting with the first electromagnetic signal S₁ causes the emission of a second electromagnetic signal S₂ that may exhibit certain electrical characteristics that are the equal to or different from those of the first electromagnetic signal S₁ (e.g., frequency and wavelength, polarization, etc.).

Thus, in the latter case, the target k has its own antenna suited to allowing the reception of the first electromagnetic signal S₁ and the transmission of the second electromagnetic signal S₂.

The conformation of an active target k suited to receive and transmit, respectively, a first S₁ and a second S₂ electromagnetic signal is per se known in the technical field in which the present invention is related and for that reason will not be further described in the following.

Conveniently, each module 2 used by the system will be suited to comprise at least two antennas 3 arranged to receive the second electromagnetic signal S₂.

From the foregoing, it is possible to highlight that each module 2 is equipped with antennas 3 suited to transmit the first electromagnetic signal S₁ in the three-dimensional reference space and to receive the second electromagnetic signal S₂ generated by the target k as a result of the interaction occurring between the target k and the first electromagnetic signal S₁.

Each module consists of a predetermined number of antennas 3 referred to in the present description as “second number” and will be denoted with the reference letter N.

Conveniently, the antenna modules 2 may have at minimum one pair of antennas 3, at least one of which is transmitting.

For this reason, in the present description the second number N should be understood to be greater than or equal to two (N>=2).

Conveniently, the system 1 also comprises a radio chain 4 operatively connected to the plurality of antenna modules 2.

The expression “radio chain” 4 used in the present description intends to identify an electronic device suited to: i) generate predetermined first and second electrical signals s₁, s₂ suited to be sent to the antenna modules 2, ii) receive and process the first and second electrical signals s₁, s₂ coming from the antenna modules 2 in order to determine certain parameters associated therewith.

The radio chain 4 is configured to send a first electrical signal s₁ to all antenna modules 2 and receive from them a second electrical signal s₂.

Specifically, when module 2 is configured to operate in bidirectional mode (transmitter/receiver), the first electrical signal s₁ with which radio chain 4 feeds the various modules 2 will permit to trigger the resonance condition of the transmitting antenna 3 present in the modules 2 so as to promote the radiation of the first electromagnetic signal S₁ in three-dimensional space.

The receiving antennas 3 of each module 2 have an output operatively connected to the radio chain 4, said antennas 3 are configured to receive the second electromagnetic signal S₂ and provide at their output a second electrical signal s₂ whose parameters depends on the parameters associated with the second electromagnetic signal S₂.

The radio chain 4 is configured to detect the second electrical signal s₂ and process it for extracting the information contained in some parameters associated with the second electrical signal s₂.

For example, the radio chain 4 will be suited to determine information about the phase, amplitude a waveform associated with the second electrical signal s₂ (and consequently associated with the second electromagnetic signal S₂).

The radio chain 4 has an output operatively connected to electronic processing means 5.

In particular, the electronic processing means 5 may comprise at least one CPU 6 suited to process all the electrical signals s₁, s₂ generated and received by the system 1, and a control logic unit 7 operatively connected to such CPUs 6 and suited to control the activation and operation of the various components of the system 1.

The information processed by the radio chain 4 on the basis of the second electrical signal s₂ is provided to the processing means 5 and in particular through the output present in the radio chain 4 such information is shared with the CPU 6.

The CPU 6 has a memory in which operational instructions are stored to process information from the radio chain 4 so as to obtain indications of the position of the target k located within the reference space.

In particular, the CPU 6 may be programmed to determine the position of the target k with respect to the reference point p through an algorithm designed to define the time of flight of the signal (Time of Flight—ToF) and the angle of arrival of the signal (Angle of Arrival—AoA).

Through of the determination of ToF and AoA, the CPU 6 can estimate the position assumed by the target k with respect to the reference point p at a given instant of time.

To determine the position of the target k, therefore, system 1 subject of the present invention operates in the following way:
generation (by the radio chain 4) of a first electrical signal s₁ having predetermined electrical signals;
sending such signal s₁ to the respective antenna modules 2;
radiation of a first electromagnetic signal S₁ in the reference space;
reception of a second electromagnetic signal S₂ associated with target k;
transduction by antenna modules 2 of the second electromagnetic signal S₂ into a second electrical signal s₂;
sending the second electrical signal s₂ to the radio chain 4;
processing carried out by the radio chain 4 on the second electrical signal s₂ so as to extract information associated with the second electrical signal s₂;
sending the information detected by the radio chain 4 to the processing means 5;
processing of the information in output from the radio chain 4 to determine the position of the object in accordance with algorithms based on ToF and AoA.

Conveniently, the system 1 comprises at least one first switching device interposed between the radio chain 4 and the plurality of antenna modules 2.

In the system schemes shown in FIG. 4 and in FIG. 5, the first switching device is referred to with the reference number 8.

From a circuitry perspective, the first switching device 8 may consist of a switch having a single input and a plurality of outputs.

Such a switch will also be equipped with a control gate through which device 8 can be controlled so as to promote the selective electrical connection between the single input and one among the outputs.

Conveniently, the control port associated with the first switching devices (switches) 8 is connected to the control logic 7 associated with the processing means 5.

For this reason, the selective connection of the input of the first switching device 8 to a single output at a time is controlled by the control logic unit 7.

Therefore, the switches (and more generally the switching devices 8) are configured to provide a selective electrical connection between the input and a single output at a time.

In particular, the switch used in the present system will be of the bidirectional type and, therefore, the signals passing through it can be directed in the two directions:
from the input to one of the outputs (corresponding to the output selected at that instant of time);
from the selected output to the input.

It is therefore apparent that in the present context the definition of input and outputs associated with the switching devices 8 is entirely arbitrary, since definition thereof depends on the direction of the signal passing through that device.

According to a specific aspect of the present invention, the plurality of outputs of the first switching device 8 is operatively connected to at least one antenna 3 of each module 2.

In the present description, two particular configurations of the system 1, subject of the present invention, are illustrated.

The first configuration of such system 1 is schematized in FIG. 4.

This configuration involves the use of a plurality of first switching devices 8 chosen in such a way that their number is equal to N, that is equal to the number of antennas 3 contained in each module M.

The single input of each first switching device 8 is operatively connected to the radio chain 4.

Each first switching device 8 has a number of outputs equal to a M, that is the number of modules 2 used in the system 1.

Thus, in this configuration, a number of first switching devices 8 equal to the number of antennas N contained in each module M; in addition, each individual switching device 8 has a number of outputs equal to the number of modules M used in system 1.

The outputs of each individual switching device 8 are connected to respective antennas 3 contained in different modules 2 (however, the outputs of each individual switching device 8 are connected to all modules 2 of the system 1, and in particular to a single antenna 3 contained in each of such module 2).

In the example of FIG. 4, the system 1 comprises a number of modules M equal to four (M=4) and a number N of antennas 3 equal to ten (N=10).

For this reason, ten first switching devices 8 each having four outputs are to be used.

The output of a single switching device 8 is operatively connected to a respective antenna 3 associated with different modules; therefore, four antennas 3, each of them belonging to a different module 2, are connected to each switching device 8.

Control logic unit 7 will be suited to control the first switching devices 8 so as to selectively connect the antenna 3 associated with a specific module 2 with the radio chain 4.

Conveniently, the control logic unit 7 will be suited to control the switching of the inputs of the first devices 8 to the single output to promote the selective connection of the radio chain 4 with a single antenna 3 at a time included in the various modules 2.

Operatively, the control logic unit 7 will be suited to control the respective switching devices 8 so as to provide the radio chain 4 with a plurality of second signals s₂ each of them coming from a different antenna 3 contained in the same module 2.

To better clarify this aspect, in the scheme in FIG. 4 each antenna module 2 has been marked with a sequential number.

In particular, the left module has been assigned the number 1, the bottom module has been assigned the number 2, the right module has been assigned the number 3 and the top module has been assigned number 4.

The antennas 3 contained in each module 2 have also been indicated in the scheme in Figure with a sequence number comprised between 1 and N.

As previously described, each switching device 8 is connected to a respective antenna 3 of each module 2.

In the scheme of FIG. 4, the first switching device 8 located on the left and indicated by the sequence number no. 1 has outputs connected to the first antenna 3 of each module 2.

Similarly, the second switching device 8 (shown in the scheme in FIG. 4 with the sequence number 2) has outputs connected to the second antennas 3 of each module 2.

Following this connection mode, the last switching device (indicated in the scheme in FIG. 4 by the letter N) has outputs connected to the antenna N of each module 2.

Operatively, at instant t₀, the control logic unit 7 will be suited to control all the switching devices 8 in such a way as to provide the respective outputs of the latter with a second electrical signal s₂ coming from all the antennas 3 of module no. 1.

This connection configuration will be maintained for a predetermined time interval Δt.

At time instant t₁=t₀+Δt, the control logic unit 7 will promote the substantially simultaneous switching of all switching devices 8 such that they present, at their outputs, a second signal s₂ coming from all antennas 3 contained in module no. 1.

At time instant t₁=t₀+Δt, the control logic unit 7 will promote the substantially simultaneous switching of all switching devices 8 such that they present, at their outputs, a second signal s₂ coming from all antennas 3 contained in module no. 2.

At time instant t₂=t₀+2Δt=t₁+Δt, the control logic unit 7 will promote the substantially simultaneous switching of all switching devices 8 such that they present, at their outputs, a second signal s₂ coming from all antennas 3 contained in module no. 3.

At time instant t₃=t₀+3Δt=t₂+Δt, the control logic unit 7 will promote the substantially simultaneous switching of all the switching devices 8 such that they present, at their outputs, a second signal s₂ coming from all antennas 3 contained in module no. 4.

At time instant t₄=t₀+4Δt=t₃+Δt, the control logic unit 7 will promote the substantially simultaneous switching of all switching devices 8 in such a way that they again present, at their outputs, a second s₂ signal from all antennas 3 contained in module no. 1.

In system 1, which is the subject of the present invention, the control logic unit 7 is suited to provide a switching signal (of repetitive in time or non-repetitive in time type) and generated at each reconfigurable instant of time Δt.

For this reason, in the scheme of FIG. 4, the control logic unit 7 substantially operates as a clock device suited to switch the signals reception from a predetermined antenna module 2 to the next antenna module 2.

Furthermore, in the scheme illustrated in FIG. 4, the reception by radio chain 4 of the second signals s₂ follows a cyclic pattern, as the connection of each antenna module 2 to the radio chain 4 itself is repeated at each time interval of the duration of (M+1)*Δt.

In other words, the connection between each antenna module 2 and the respective radio chain 4 is promoted periodically by the switching devices 8 at each time interval (M+1)*Δt.

In the case where system 1 illustrated in FIG. 4 is configured, not only to receive the second electromagnetic signal S₂ interacting with the target k and/or generated by target k itself, but also to emit a first electromagnetic signal S₁ (whose function, as described above, is to promote the generation of the second electromagnetic signal S₂).

In this case, the control logic unit 7 will be suited to activate the first communication devices so as to promote the transmission of the first electrical signal generated by the radio chain 4 to one or more modules 2.

One or more antennas 3 of said modules 2 can then be supplied with the first electrical signal s₁ so as to radiate the first electromagnetic signal S₁ in the portion of space associated with such module. The radiation of such first electromagnetic signal S₁ by one (or more) antennas 3 of a respective module 2 can be maintained for a predetermined time.

Following the transmission of the first electromagnetic signal S₁ in the three-dimensional space covered by respective antenna modules 2, the system 1 can stand by to receive a second electromagnetic signal S₂ associated with target k and located within such space.

From this point on, the system shown in FIG. 4 will be configured to operate in the manner previously described in order to determine the position of target k present within the space.

An alternative version of system 1, which is the subject of the present invention, is illustrated in FIG. 5.

In this case, system 1, subject of the present invention, comprises a plurality of second switching devices 9 each having a single input and a plurality of outputs.

In particular, each second switching device 9 will have a number of outputs equal to N.

Each output of the switching device 9 is connected to a respective antenna 3 of the same module 2.

Therefore, each antenna module 2 corresponds to a single second switching device 9 whose outputs are connected to antennas 3 of module 2.

For this reason, the number of second switching devices 9 coincides with the number M of modules 2 used in system 1; in other words, each module 2 corresponds to a single second switching device 9.

Also with reference to the second switching device 9, the nomenclature of the inputs and outputs is interchangeable:
device 9 has a single input and a plurality of outputs when the latter is traversed by the first electrical signal s₁ suited to supply the antennas 3 to promote the radiation of the first electromagnetic signal S₁ in the reference space;
device 9 has a plurality of inputs and a single output when the latter is traversed by the second electrical signal s₂ generated from the second electromagnetic signal S₂ received by the antennas 3 of the respective module 2.

Conveniently, the single input of each second switching device 9 is operationally connected to a respective output of the first switching device 8 (in this case, the input/output nomenclature refers to transmission mode).

In the configuration of FIG. 5, therefore, there is a single first switching device 8 having a number of outputs equal to M, that is, equal to the number of antenna modules 2 present in system 1.

The second switching devices 9 are operationally connected with the radio chain 4.

The connection of an antenna 3 contained in a given module 2 with the output of the respective second switching device 9 is, in fact, controlled by radio chain 4.

In this type configurations of system 1, the activation of the first switching device 8 is controlled by the control logic unit 7 while the second switching devices 9 are instead controlled by the radio chain 4 (or, rather, by the electronic logic implemented within the radio chain 4).

Conveniently, the activation of the first switching device 8 and the activation of the second switching device 9 can be completely autonomous and independent of each other.

The expression “autonomous and independent” above-mentioned is intended to refer to the fact that i) the switching of the first switching device 8 is promoted by the electronic control unit 7 without waiting for or receiving any information from the radio chain 4, ii) the switching of the second switching device 9 is promoted by the radio chain 4 without waiting for or receiving any information from the electronic control unit 7.

Thus, from a practical point of view, the activation of the first switching device 8 is promoted without the electronic control unit 7 receiving signals associated with the switchings of the second switching devices 9. Similarly, the activation of the second switching device 9 is promoted without the radio chain 4 receiving signals associated with the switchings of the first switching devices 8.

Hereinafter will be described the operation of the system shown in FIG. 5 when it operates only in receive mode or in transmission/reception mode.

At instant t₀, control logic unit 7 will promote the switching of the first device 8 to establish a connection (i.e., electrical continuity) between radio chain 4 and the second switching device 9 associated with antenna module no. 1.

This configuration is maintained for an interval of time Δt′ in order to establish a connection between the input of the second switching device 9 and the transmitting antenna 3 of antenna module no. 1.

In this way, it will be possible to feed the transmitting antenna 3 associated with module no. 1 with the first electrical signal s₁ to promote the propagation of the first electromagnetic signal S₁ in the reference space.

At time instant t₁=t₀+Δt′, the radio chain 4 will be suited to control the second switching device 9 so as to establish a contact with the second antenna 3 of the module 2 denoted by no. 1.

During time t₁, the radio chain 4 will receive a second signal s₂ coming from the second antenna 3 of the module 2 indicated with no. 1.

At the time instant t₂=t₀+2Δt′=t₁+Δt′, the radio chain 4 will be suited to control the second switching device 9 so as to establish contact with the third antenna 3 of the module 2 referred to with no. 2.

During time instant t₂, the radio chain 4 will receive a second signal s₂ coming from the third antenna 3 of the module 2 referred to with no. 2.

At time instant t₃=t₀+3Δt′=t₂+Δt′, the radio chain 4 will be suited to control the second switching device 9 so as to establish a contact with the fourth antenna 3 of the module 2 referred to with no. 3.

During time instant t₃, the radio chain 4 will receive a second signal s₂ coming from the fourth antenna 3 of the module 2 referred to by no. 3.

Continuing according to this logic, at time instant t_{N-1}=t₀+(N−1)*Δt′, the radio chain 4 will be suited to control the second switching device 9 to establish a contact with the last antenna N of module 2 referred to as N.

During the time tₙ₋₁, radio chain 4 will receive a second signal s₂ coming from the last antenna N of module no. 1.

During the time interval equal to t₀+t₁+t₂+ . . . +tₙ₋₁ the control logic unit 7 will keep the switching of the first device 8 stable so that it will promote the electrical connection between the radio chain 4 and the second switching device 9 associated with the antenna module 2 denoted by no. 1.

It is, therefore, possible to define a duration Δt of the switching established between the first switching device 8 and the antenna module indicated with no. 1, the value of Δt can be calculated as follows:

$$Δ t = {t}_{0} + {t}_{1} + {t}_{2} + … + {t}_{N - 1}$$

At time instant 2Δt, the control logic unit 7 will promote the switching of the first device with the second switching device 9 associated with the antenna module indicated by no. 1.

The foregoing is also repeated for module no. 2, i.e., at instant t₀ the supply of the transmitting antenna 3 of module no. 2 with the first electrical signal s₁ will be promoted, while at instants t₁, t₂ . . . t_{N-1} the reception of the second signals s₂ coming from all antennas 3 of module no. 2 will be promoted.

At time instant 3Δt, logic unit 7 will promote the switching of the first device 8 with the second switching device 9 associated with antenna module no. 3.

The foregoing is also repeated for module no. 3, i.e., at instant t₀ the supply of the transmitting antenna 3 of module no. 3 with the first electrical signal s₁, while at time instants t₁, . . . , tₙ₋₁ the reception of the second signals s₂ coming from all the antennas 3 of module no. 3 will be promoted.

At time instant 4Δt, logic unit 7 will promote the switching of the first device 8 with the second switching device 9 associated with antenna module no. 4.

The foregoing is also repeated for module no. 4, i.e., at instant t₀ the supply of the transmitting antenna 3 of the module no. 4 with the first electrical signal s₁, while at instants t₁, . . . t_{N-1} the reception of the second signals s₂ coming from all the antennas 3 of the module no. 4 will be promoted.

At time instant 5Δt, logic unit 7 will again promote the switching of the first device 8 with the second switching device 9 associated to antenna module no. 1.

The connection of the first switching device 8 to the second switching devices 9 thus follows a cyclic trend, whose period is equal to (M+1)*Δt.

Conveniently, in a similar way to what has already been exposed in the configuration of system 1 illustrated in FIG. 4, also in the example of FIG. 5 there may be a preliminary phase of activation of the first switching device 8 and of the second switching device 9 so as to promote submission to one or more antenna module 2 of the first electrical signal s₁ so as to allow the radiation in the space of the first electromagnetic signal S₁.

Following this first preliminary phase of transmitting the first electromagnetic signal S₁, the system 1 will be suited to set up to receive the second electromagnetic signal S₂ according to the modes above-mentioned with reference to the version illustrated in FIG. 5.

The present invention can be carried out in other variants, all falling within the scope of the inventive features claimed and described herein; said technical features can be replaced by different technically equivalent elements and materials; the shapes and dimensions of the invention can be any as long as they are compatible with its use.

The reference numbers and signs included in the claims and in the description are only intended to make the text clearer to understand and must not be considered as elements limiting the technical interpretation of the objects or processes identified by them.

The invention claimed is:

1. A system for determining a position of a target located within a reference space, using a radiation within the reference space of an electromagnetic signal containing information associated with the target, the system comprising:
a plurality of modules of antennas, each of which is formed by at least two antennas configured to receive the electromagnetic signal containing information associated with the target;
a radio chain operatively connected to said plurality of modules of antennas, said radio chain being configured to receive from each module an electrical signal associated with said electromagnetic signal;
at least one first switching device interposed between said radio chain and said plurality of modules of antennas; and
a processor operatively connected to said radio chain to process information associated with the electrical signal received by said radio chain,
wherein said at least one first switching device has a single input operatively connected to said radio chain and a plurality of outputs, the plurality of outputs of said at least one first switching device being operatively connected to each module of antennas of said plurality of modules.

2. The system according to claim 1, further comprising a predetermined number of said modules of antennas, each module being constituted by a predetermined number of said antennas.

3. The system according to claim 1, wherein said processor comprises a CPU unit operatively associated to a control logic unit, said control logic unit being controlled by said CPU unit.

4. The system according to claim 3, wherein said control logic unit has one or more outputs operatively connected to each of said first switching devices, a switching of each first switching device being controlled by said control logic unit.

5. The system according to claim 4, wherein the system comprises a number of said first switching devices equal to a number of the antennas contained in each module of said plurality of modules, each first switching device having a single input operatively connected to said radio chain.

6. The system according to claim 5, wherein each first switching device has a number of outputs equal to a number of the modules of said plurality of modules.

7. The system according to claim 6, wherein the outputs of a same first switching device are respectively connected to the antennas belonging to distinct modules, each first switching device being connected to all modules of antennas of said plurality of modules.

8. The system according to claim 1, further comprising a first switching device provided with a single input operatively connected to said radio chain and a plurality of outputs.

9. The system according to claim 8, wherein said single first switching device has a number of outputs equal to a number of the modules of antennas of said plurality of modules.

10. The system according to claim 8, further comprising a plurality of second switching devices, each of which has a single input and a plurality of outputs.

11. The system according to claim 10, wherein a number of said second switching devices is equal to a number of said modules of antennas, a number of the plurality of outputs associated with each of said second switching devices being equal to the number of antennas configured to define the respective modules of said plurality of modules.

12. The system according to claim 10, wherein an input of each second switching device is operatively connected to a respective output of said first switching device.

13. The system according to claim 12, wherein the outputs of each second switching element are connected to all the antennas constituting a respective module of said plurality of modules.

14. The system according to claim 1, wherein said radio chain is configured to send to one or more modules of antennas (3) of said plurality of modules a corresponding first electrical signal.

15. The system according to claim 14, wherein said plurality of modules of antennas are configured to receive said first electrical signal generated by said radio chain and to radiate in the reference space a corresponding first electromagnetic signal associated to said first electrical signal, said electromagnetic signal received by said plurality of modules of antennas being variable as a function of the first electromagnetic signal radiated in the reference space.
